(19) United States
(12) Patent Application Publication
(10) Pub. No.: US 2013/0239828 A1
(43) Pub. Date: Sep. 19, 2013

(54) ANTI-COUNTERFEIT PRINTING MATERIAL WITH A HOT STAMPING TEXTURE, SPECIAL HOT STAMPING FOIL AND MANUFACTURING METHOD FOR THE SAME

(71) Applicants: Mingfa Chen, Haikou (CN); Fei Chen, Haikou (HN)

(72) Inventors: Mingfa Chen, Haikou (CN); Fei Chen, Haikou (HN)

(73) Assignee: HAINAN YAYUAN ANTI-FRAUD TECHNIQUE INSTITUTE, Haikou (CN)

(21) Appl. No.: 13/880,979

(22) PCT Filed: Jul. 22, 2011
(86) PCT No.: PCT/CN2011/077515

§ 371 Date: Apr. 23, 2013

(30) Foreign Application Priority Data
Oct. 27, 2010 (CN) 201010520429.5
May 17, 2011 (CN) 201110126589.6

(51) Int. Cl. B41M 3/14

(52) U.S. Cl. CPC B41M 3/14
USPC 101/31

(57) ABSTRACT

The present invention provides an anti-counterfeit printing material with a hot stamping texture, a special hot stamping foil and a manufacturing method for the same. The method comprises the steps of: randomly throwing fibers onto a foil printed with an adhesive to form a hot stamping foil; scanning and collecting characteristic information about the random distribution of fibers; and storing the characteristic information in a database of a computer anti-counterfeit inquiry system connected to a telephone network and/or Internet, for public inspection and verification of authenticity. With existing hot stamping processes and equipment, a printing material manufacturer can produce an anti-counterfeit printing material with a local texture in the background by means of hot stamping with hot stamping foils. The present invention saves huge investment in special equipment, simplify production process, increase production efficiency, reduce production costs.

### CROSS-REFERENCE TO RELATED APPLICATION

This application is the U.S. national phase of International Application No. PCT/CN2011/077515, filed on 22 Jul. 2011, which claims the priority benefit of two Chinese Patents which are application No. 201010520429.5 filed on Oct. 27, 2010 and application No. 201110126589.6 filed on May 17, 2011. the entire contents of which is hereby incorporated by reference.

### BACKGROUND OF THE INVENTION

1. Field of the Invention

The present invention relates to the field of anti-counterfeit printing, and in particular to an invention dependent from Chinese Patent entitled “Anti-counterfeit printing material with a local texture” (CN 200810091444.5), a special hot stamping foil and a manufacturing method for the same. In particular, the present invention provides a further new anti-counterfeit technique by using fibers, which makes a breakthrough in the limit regarding Chinese Patent entitled “Structural texture anti-counterfeit method” (CN99801139.8).

2. Background of the Invention

The Chinese patent application entitled “structural texture anti-counterfeit method”(CN99801139.8) of one of the present inventors (Chen Mingfa) has been filed as an International patent (PCT/CN99/00102), and has been granted Chinese patent, US patent (Certificate No. US6623041), Russian patent (Certificate No. 2202127), Korean patent (Certificate No. 0419436), Vietnam patent (Certificate No. 3347) or the like. Material whose random structural texture (e.g., texture formed by adding fibers into paper) is clear (i.e., carrier) is selected as anti-counterfeit identifier. An unique identifying number is printed on the carrier. The random structural texture characteristic information on the identifier is scanned and collected as anti-counterfeit identifying characteristic information (i.e., base for verifying authenticity), and stored along with the identifying number in a database of a computer anti-counterfeit inquiry system connected to a telephone network and/or Internet. By means of communication tools like telephone, SMS, MMS, fax, 3G, WAP, a computer in the Internet, the public can verify authenticity by inputting the identifying number to inquire whether the random structural texture on the identifier coincides with the anti-counterfeit characteristic information stored in the database. This patent “grafts the ancient Hufu anti-counterfeit principle with the modern communication and computer technology”, creates a new anti-counterfeiting field, and is named as “the world's first, international leading, extremely difficult to counterfeit, easy to identify, and long-term effective” anti-counterfeit technical product in a national accreditation appraisal organized by “National Security Office” and Chinese Security Industry Association. After more than ten years of promotion, it has now become the mainstream anti-counterfeit products in the domestic anti-counterfeit market. However, during practical application, the following problems occur. \textcircled{1} Printing or packaging paper with structural texture (fibers) and meeting requirements is special paper, instead of universal standard paper, and therefore should be specially manufactured for exclusive use, thus having drawbacks of huge investment, high cost, long order cycle, less varieties, and difficult to meet requirements for a variety of printed packaging paper. The colored fibers in papermaking also caused environmental pollution. \textcircled{2} The fabricated paper is distributed with fibers all over, and the fibers destroy design layout like impurities and affect the beauty of the printed package. \textcircled{3} In implementation in which a sticker texture anti-counterfeit label pastes on the product, a labeling step is added for the user, which not only increases the cost of use but also present trouble for the user. In a more serious case, counterfeiters may use a hair dryer to blow (by heating and melting) the sticker so that the sticker is no longer sticky, completely lift the label and paste it on the counterfeit products, so that the anti-counterfeit labels become amulet of counterfeit products. Furthermore, “Structural texture anti-counterfeit method”(CN99801139.8) states in paragraph [0016] of its description that, in order to overcome the drawback of “Antiforgery cipher trademark” (CN92109558.9) in its background, “the structural texture of the invention is an intrinsic structure of the material of the carrier itself”. Another inventor of the present invention (Chen Fei) filed on Oct. 27, 2008 a Chinese patent application entitled “An anti-counterfeit printing material with a local texture”(CN 200810091444.5), which discloses in its seventh embodiment (see FIG. 11 of the present invention) a technique of randomly sticking fibers directly on the surface of printing material to fabricate a “texture anti-counterfeit identifying layer”, and the “texture anti-counterfeit identifying layer” in sequence comprises a protection layer (9), a fiber layer (4), and an adhesive layer (8). Characteristic information about the random distribution of fibers is collected as an anti-counterfeit identifying characteristic information (i.e., base for verifying authenticity), and stored along with the identifying number in a database of a computer anti-counterfeit inquiry system connected to a telephone network and/or the Internet. By means of communication tools like telephone, SMS, MMS, fax, 3G, WAP, a computer in the Internet, the public can verify authenticity by inputting the identifying number to inquire whether the random structural texture on the identifier coincides with the anti-counterfeit characteristic information stored in the database. During implementation of the seventh embodiment in the above mentioned patent, the present applicant found that it suffers from the drawbacks of huge investment, low efficiency, complicated process, workshop pollution due to fibers and dust during sifting fibers. For example, a production line, which is constituted by special equipments like screen printing machine, powder sprayer, digital printing machine, image scanning and shooting device, UV dryer, coating or polishing machine, and may cost the printing material (e.g., medicine box or cigarette case) manufacturer more than four million CNY, can only develop a daily production capacity of 100 thousands boxes (texture anti-counterfeit medicine box), which is an extremely low production efficiency.

In Baidu Encyclopedia, the technical note about “heat transfer color film” follows. The heat transfer color film refers to such a special functional printing film in which under heat and pressure, graphics and text with an adhesive are separated from the carrier thin film along with the release layer, and firmly transferred onto the surface of printed material. The heat transfer film generally is constituted by 3-5 layers. A three-layer heat transfer film is constituted by a carrier layer (the first layer), a printed layer (the second layer), and a gluing layer (the third layer). A four-layer heat transfer film is constituted by a carrier layer (the first layer), a release layer (the second layer), a printed layer (the third layer), and a gluing layer (the fourth layer). A five-layer heat transfer film is constituted by a carrier layer (the first layer), a release layer (the second layer), a printed layer (the third layer), a gluing layer (the fourth layer), and a hot melting glue powder layer (the fifth layer). Generally, the second, third, fourth and fifth layers are referred to as a transfer layer or hot stamping layer. The “heat transfer color film ” is generally also referred to as “a hot stamping foil”. The requirements and functions for each layer are described here by taking a four-layer transfer film as an example. The carrier layer, i.e., a carrier on which the release agent, ink, and adhesive is coated, is required to be resistant to temperature and pressure and have small tensile deformation. The release layer, i.e., a coating of release agent, is required to maintain a solid state at room temperature, can be melted at a certain temperature, so that the binding force with the carrier layer reduces and can be separated from the carrier layer fast without adhesion residues. The release agent plays a key role for the printed layer to separate from the carrier layer and to transfer to the surface of printed material. It is required to have good abrasion resistance, protect the color ink, reduce the intensity of UV radiation, reduce invasion of adverse effects on the ink in the air, extend the usage period of ink, and buffer the adhesion of the carrier film and the printed layer. The printed layer is fundamental for the quality and beauty of transfer products. With the development of printing and image processing technique, the printed layer can have a variety of colors and patterns. Especially the graphics and text formed by gravure printing can well reflect the delicate graphics and text, producing a more perfect packaging decorative effect. The gluing layer is the gluing layer (5) of the present invention, and has a basic performance to present a high binding force with the surface of printed material and ensures that the printed layer is firmly bound with the surface of printed material. This adhesive layer should match with the printed material. Different adhesives exhibit different binding force with the printed material due to their difference in chemical composition. Selection should be based on different printed materials, which may be a hot melting glue or cold melting glue.

### BRIEF SUMMARY OF THE INVENTION

An object of the present invention is to provide an anti-counterfeit printing material with a hot stamping texture, a special hot stamping foil and a manufacturing method for the same, so that with existing hot stamping processes and equipment, a printing material manufacturer can produce “an anti-counterfeit printing material with a local texture” in the background by means of hot stamping with hot stamping foils. As a result, the present invention saves huge investment in special equipment, simplify production process, increase production efficiency, reduce production costs, avoids workshop pollution; and makes a breakthrough in the limit regarding “texture” in the background by providing a further new anti-counterfeit technical measure by using fibers.

The technical solution for the anti-counterfeit printing material with a hot stamping texture of the present invention follows.

An anti-counterfeit printing material with a hot stamping texture, the anti-counterfeit printing material comprises fibers (1), characteristic information about the random distribution of fibers (1) is collected and stored in a database of a computer anti-counterfeit inquiry system connected to a telephone network and/or the Internet, for public inspection and verification of authenticity, characterized in that the anti-counterfeit printing material comprises:

\textcircled{1} a printing material body (3);

\textcircled{2} an identifying number (2), which is arranged on the printing material body (3) or on an anti-counterfeit identifying layer with a hot stamping texture (11);

\textcircled{3} an anti-counterfeit identifying layer with a hot stamping texture (11), which comprises in sequence a release layer (9′), an adhesive layer (8), a fiber layer (4) with randomly distributed fibers (1) and a gluing layer (5); said release layer (9′) doubles as a protection layer (9); as used herein, the term “in sequence” should be broadly understood, and of course comprises a new layer (e.g., a white ink substrate layer) which is inserted between the above mentioned layers;

\textcircled{4} the anti-counterfeit identifying layer with a hot stamping texture (11) is hot stamped and bound (transferred) onto the printing material body (3) by the gluing layer (5).

It has been found in process experiments that 99% of fibers (1) can be transferred onto the printing material body (3) along with the anti-counterfeit identifying layer with a hot stamping texture (11), while about 1% of fibers (1) retains on the carrier layer (6) due to weak adhesion with the printing material body (3). This leads to 1% waste and large amount of labor cost for removing the waste, making it impossible to realize fully automated production. To solve this technical problem, the present applicant found that covering the surface of fibers (1) with a hot melting glue layer (10) with a melting point of 80-140° C. can impart the fibers (1) itself an excellent adhesion. In this way, it is possible to overcome the above mentioned drawback, so that 100% of fibers (1) can be transferred onto the printing material body (3) along with the anti-counterfeit identifying layer with a hot stamping texture (11). Especially when 1.5-3.2% ethoxylated alkyl amine and 2-5% rosin powder are added into the glue for forming the hot melting glue layer (10), an unexpected excellent dispersion effect can be realized in which the fibers neither wind nor clot. Besides, the fibers (1) can be firmly bound onto the printing material body (3).

To enhance handle of fibers (1), thus facilitating the consumer to touch the fibers (1) with hands during inspection and verification of authenticity, the surface of said fibers (1) is coated with a foaming microsphere layer (not shown in the figure). In this way, the foaming microsphere layer on the surface of fibers (1) will protrude upon hot stamping due to heating and foaming, so that the fibers (1) can present a significant protruding handle.

To prevent counterfeiter from printing imitated fibers (1), said fibers (1) preferably are multi-color segment metallic luster fibers (not shown in the figure). The ordinary skilled in the art of printing knows that graphics and text with metallic luster can only be realized by a hot stamping process, while the current hot stamping film is monochromatic, such as gold, silver, or other mono-color, and hot stamping films in variety of colors are not available. If the counterfeiter wants to form imitated fibers by hot stamping, the hot stamping should be performed for several times to print a multi-color segment fibers. In addition, the accuracy of hot stamping of the hot stamping machine is only 0.1 mm or higher. Therefore, the fibers as printed are inevitably misaligned and interrupted continuous, and do not have neat and smooth edge like the real fibers. Therefore, by using multi-color segment metallic luster fibers, the difficulty of imitation for fibers can be significantly increased.

The fibers (1) are magnetic fibers which can be attracted by a magnet and overcome their own gravity to fly towards the magnet, for example, iron-containing fibers, nickel-containing fibers or the like. In this way, the fibers (1′) which are not adhered at a region beyond the adhesive layer (8) can be attracted by the magnet and removed completely, so as to avoid polluting printed material and the user workshop during use in hot stamping.

To facilitate the consumer to scrape fibers (1) for verifying whether fibers are fake fibers imitated by a printing ink, a UV isolating oil layer is preferably printed on the printing material body (3) at the place where said anti-counterfeit identifying layer with a hot stamping texture (11) is located.

To further increase difficulty of imitation and enhance anti-counterfeit effect and aesthetic effect, it is preferred to arrange a laser holographic (anti-counterfeit) layer (13) in the anti-counterfeit identifying layer with a hot stamping texture (11) (between any two layers).

In summary, the anti-counterfeit printing material with a hot stamping texture of the present invention can adopt any combination of the following seven technical features, but can adopt at least one of the following technical features, according to the process requirement during practical production:

\textcircled{1} the surface of said fibers (1) is coated with a hot melting glue layer (10) with a melting point of 80-140° C.; or the surface of said fibers (1) is coated with a foaming microsphere layer;

\textcircled{2} said identifying number (2) is an aluminum washing identifying number (2′);

\textcircled{3} said fibers (1) are multi-color segment metallic luster fibers;

\textcircled{4} said fibers (1) have a length or particle diameter ≧0.4-0.6mm; because it is difficult to identify for a dimension of less than 0.4 mm, and it is not convenient to produce for a dimension of larger than 3.2 mm;

\textcircled{5} said anti-counterfeit identifying layer with a hot stamping texture (11) is embedded with a laser holographic layer (13);

\textcircled{6} a UV isolating oil layer is printed on the printing material body (3) at the place where said anti-counterfeit identifying layer with a hot stamping texture (11) is located;

\textcircled{7} the area of said gluing layer (5)≧the area of the anti-counterfeit identifying layer with a hot stamping texture (11)>the area of the fiber layer (4)>the area of the adhesive layer (8).

The technical solution of a special hot stamping foil for an anti-counterfeit printing material with a hot stamping texture of the present invention follows.

A special hot stamping foil for an anti-counterfeit printing material with a hot stamping texture, comprising an anti-counterfeit information layer, the anti-counterfeit information of the anti-counterfeit information layer is stored in a database of a computer anti-counterfeit inquiry system connected to a telephone network and/or the Internet, for public inspection and verification of authenticity, characterized in that the special hot stamping foil comprises:

\textcircled{1} a carrier layer (6);

\textcircled{2} an anti-counterfeit identifying layer with a hot stamping texture (11): which comprises in sequence a release layer (9′), an adhesive layer (8), a fiber layer (4) with randomly distributed fibers (1) and a gluing layer (5), wherein one side of said release layer (9′) is in contact with said carrier layer (6), while said gluing layer (5) is to be in contact with a printing material body (3);

\textcircled{3} pieces of anti-counterfeit identifying layer with a hot stamping texture (11) (of an area which is required for identification) are arranged on said carrier layer (6) at a certain spacing;

\textcircled{4} an identifying number (2) layer is further printed in each piece of anti-counterfeit identifying layer with a hot stamping texture (11);

\textcircled{5} said fiber layer (4) is said anti-counterfeit information layer, and characteristic information about the random distribution of said fibers (1) is said anti-counterfeit information.

The region of the anti-counterfeit identifying layer with a hot stamping texture (11) (i.e., identifying region) on the hot stamping foil (16) as mentioned above, is stuck with a layer of relative thick fibers (1). As a result, the hot stamping foil (16) is thick in some regions while thin in other regions. This may cause a problem in which it is impossible to realize a reel with a smooth surface, a neat end face, and a large radius for the reel after winding, and the reel even can not be used. To solve this problem, a mat layer (12), which will not be transferred by hot stamping, may be printed on the carrier layer (6) (front or back side) at a region beyond the anti-counterfeit identifying layer with a hot stamping texture (11) (i.e., non-identifying region). For example, the mat layer (12) is an ink layer, bump, or adhesion layer which can increase the thickness, such as a thick foamed ink layer, a thick ink layer free from a gluing layer (5) or the like. The thickness of the mat layer (12) preferably is equal to or larger than that of the anti-counterfeit identifying layer with a hot stamping texture (11). In this way, once the region beyond the anti-counterfeit identifying layer with a hot stamping texture (11) is raised by the mat layer (12), the wound hot stamping foil can have a smooth surface, a neat end face, and a large radius for the reel, so as to facilitate use.

It has been found in process experiments that at a region beyond the anti-counterfeit identifying layer with a hot stamping texture (11) (i.e., non-identifying region), 99.99% of fibers (1) can be removed by a negative pressure powder suction machine, while the remaining fibers (1′) in a small amount have electrostatic charge which can not be removed completely and thus will be adsorbed on the carrier layer (6) of oppositely charged. To prevent the remaining fibers (1′) from dropping and polluting the user environment for subsequent procedures, a protection layer (12) (which is preferably can not be transferred during hot stamping) can further be printed on the region beyond the anti-counterfeit identifying layer with a hot stamping texture (11), so as to prevent the remaining fibers (1′) from dropping. For example, the protection layer (12) is a coating of a transparent ink or the like, so as to fully fix the remaining fibers (1′). The thick mat layer (12) mentioned above which also functions as a protection layer (12), can prevent the remaining fibers (1′) from dropping; while a thin protection layer (12) only functions to prevent the remaining fibers (1′) from dropping, and does not the function of the mat layer (12). In other words, these two kinds of protection layer can be combined with each other in case of a large thickness.

To further increase difficulty of imitation and enhance anti-counterfeit effect, it is preferred to arrange a laser holographic (anti-counterfeit) layer (13) in the anti-counterfeit identifying layer with a hot stamping texture (11) (between any two layers). Besides, the identifying number (2) is formed with a UV ink by jet printing, and then formed into an aluminum washing identifying number (2′) by the aluminum washing process, so that the difficulty of imitation is further increased.

To facilitate the consumer to scrape fibers (1) for verifying whether fibers exist, the oil scraping hot stamping back glue which is currently commercially available is preferably selected as the gluing layer (5).

To avoid sawteeth like fibers burr (7) along the edge of the anti-counterfeit identifying layer with a hot stamping texture (11), avoid an irregular edge of the identifier after hot stamping, and avoid the decrease of hot stamping speed, the area for each layer is preferably set according to the following relationship: the area of the gluing layer (5)≧the area of the anti-counterfeit identifying layer with a hot stamping texture (11)>the area of the fiber layer (4)>the area of the adhesive layer (8).

To solve the problem of weak binding, a hot melting glue layer (10) with a melting point of 80-140° C. may cover the surface of fibers (1). It is preferred to add 1.5-3.2% ethoxylated alkyl amine and 2-5% rosin powder into the hot melting glue layer (10). To enhance handle of fibers (1) , thus facilitating the consumer to touch the fibers (1) with hands during inspection and verification of authenticity, the surface of said fibers (1) is coated with a foaming microsphere layer.

To prevent counterfeiter from printing imitated fibers (1), said fibers (1) preferably are multi-color segment metallic luster fibers. To completely remove the remaining fibers (1′) and avoid polluting printed material and the user workshop during use in hot stamping, magnetic fibers which can be attracted by a magnet and overcome their own gravity to fly towards the magnet can optionally be used.

To prevent the remaining fibers (1′) along the edge of the anti-counterfeit identifying layer with a hot stamping texture (11) from affecting the smooth performance of hot stamping and transferring, a transparent ink protection layer (12) can be printed on a region at a certain distance from the anti-counterfeit identifying layer with a hot stamping texture (11). In this way, a narrow blank gap (15) is formed between the anti-counterfeit identifying layer with a hot stamping texture (11) and the protection layer (12). By using a die cutting plate which is aligned with the blank gap (15), a die cutting notch (14) is formed by die cutting, the fibers (1′) remaining therein can be cut off In summary, if the remaining fibers (1′) in the blank gap (15) are disconnected, the remaining fibers (1′) will not affect the cutting property of the hot stamping process, so that the hot stamping process can be performed smoothly at a high speed.

In summary, the hot stamping foil during practical production of the present invention can adopt any combination of the following ten technical features, but can adopt at least one of the following technical features, according to the process requirement during practical production:

\textcircled{1} a mat layer or protection layer (12) is printed on a region of said carrier layer (6) beyond the anti-counterfeit identifying layer with a hot stamping texture (11);

\textcircled{2} said anti-counterfeit identifying layer with a hot stamping texture (11) is embedded with a laser holographic layer (13);

\textcircled{3} the area of said gluing layer (5≧the area of the anti-counterfeit identifying layer with a hot stamping texture (11)>the area of the fiber layer (4)>the area of the adhesive layer (8);

\textcircled{4} said gluing layer (5) uses an oil scraping hot stamping back glue;

\textcircled{5} the surface of said fibers (1) is coated with a hot melting glue layer (10) with a melting point of 80-140° C.; or the surface of said fibers (1) is coated with a foaming microsphere layer;

\textcircled{6} said fibers (1) are multi-color segment metallic luster fibers, or magnetic fibers which can be attracted by a magnet and overcome their own gravity to fly towards the magnet;

\textcircled{7} said fibers (1) have a length or particle diameter≧0.4-0.6 mm;

\textcircled{8} said identifying number (2) is an aluminum washing identifying number (2′);

\textcircled{9} a blank gap (15) is arranged between said anti-counterfeit identifying layer with a hot stamping texture (11) and the protection layer (12), and the remaining fibers (1′) in the blank gap (15) are disconnected;

\textcircled{10} characteristic information about the random distribution of said fibers (1) is collected, and stored along with the identifying number (2) in a database of a computer anti-counterfeit inquiry system connected to a telephone network and/or the Internet, for public inspection and verification of authenticity.

A method for manufacturing an anti-counterfeit printing material with a hot stamping texture of the present invention follows.

A method for manufacturing an anti-counterfeit printing material with a hot stamping texture, comprises the steps of:

\textcircled{1} compiling and printing a identifying number (2) for a printing material body (3), which is printed on the printing material body (3), or on an anti-counterfeit identifying layer with a hot stamping texture (11);

\textcircled{2} fabricating a hot stamping foil (16): 1) coating a release layer (9′) on a side of a carrier layer (6), 2) printing an adhesive layer (8) on a release layer (9′), 3) randomly bind some fibers (1) onto the adhesive layer (8), thus forming a fiber layer (4), 4) printing a gluing layer (5) on the fiber layer (4) to fabricate an anti-counterfeit identifying layer with a hot stamping texture (11) on the carrier layer (6), thus completing a hot stamping foil (16); preferably fabricating pieces of anti-counterfeit identifying layer with a hot stamping texture (11) on said carrier layer (6) at a certain spacing;

\textcircled{3} in a state that the gluing layer (5) of the hot stamping foil (16) faces the printing material body (3), hot stamping a carrier layer (6) with a hot stamping machine, until the anti-counterfeit identifying layer with a hot stamping texture (11) on said hot stamping foil (16) is bound and transferred onto the printing material body (3);

\textcircled{4} collecting characteristic information about the random distribution of said fibers (1), and storing it along with the identifying number (2) in a database of a computer anti-counterfeit inquiry system connected to a telephone network and/or the Internet.

Said fibers (1) preferably are fibers containing a magnetic material. The remaining fibers (1′) in a region beyond the anti-counterfeit identifying layer with a hot stamping texture (11) are completely removed by the attraction of a magnet. Alternatively, a protection layer (12), like a coating, such as a transparent ink, glue or the like, is printed in a region on the carrier layer (6) beyond the anti-counterfeit identifying layer with a hot stamping texture (11), thus fully fixing the remaining fibers (1′) to avoid dropping, thus fully fixing the remaining fibers (1′).

In the present invention, fibers (1) widely refers to a small object of various shapes which can be clearly identified by naked eyes. In case that hairs, chemical fibers, metal wires, cotton threads, various existing anti-counterfeit fibers, as well as sheets, strips, particles, scraps, bubbles of various shapes are doped in the ink, since they have a large volume dimension (with a length or particle diameter≧0.6-0.4 mm), and thus act like impurities in the ink, which causes the ink cannot be used for printing. For example, an ink in which fibers with a length or particle diameter (projection diameter)>0.6-0.4 mm are doped can not be used in the printing machine.

In the present invention, the identifying number (2) can not only be natural order numbers, but also any text, letters, or an unique information of their combination (comprising a barcode, a two-dimensional code or the like). The identifying number (2) can be printed, at the customer's requirements, on any layer in the anti-counterfeit identifying layer with a hot stamping texture (11), and can be printed directly on the printing material body (3).

In the present invention, the printing material body (3) can be a product box or bag, bottle, cap, tin, or hose; a label or tag on the goods; or any article which needs anti-counterfeit, such as invoice, description of the drug, pharmaceutical packaging aluminum foil, sealing film, books, clothing, shoes, hats, bags or the like.

In the present invention, any paint, ink, or glue, which can adhere the fibers can be used for the adhesive layer (8), and its shape can be designed into various geometric shapes, lines, or art design.

In the present invention, the hot stamping foil widely refers to various hot stamping material which can be used to peel the anti-counterfeit identifying layer with a hot stamping texture (11) from the carrier layer (6) and transferred onto the printing material body (3) by such a process as hot stamping, cold stamping, or heat transferring.

In the present invention, the anti-counterfeit identifying layer with a hot stamping texture (11) refers to those layers on the hot stamping foil (16) which can be peeled from the carrier layer (6) and transferred onto the printing material body (3) upon hot stamping.

In the present invention, the region of the anti-counterfeit identifying layer with a hot stamping texture (11) and the region beyond the anti-counterfeit identifying layer with a hot stamping texture (11) can be referred to as an identifying region and a non-identifying region, respectively.

As compared with the prior art, the present invention brings about the following advantageous effects. In contrast to the Chinese patents “An anti-counterfeit printing material with a local texture (CN 200810091444.5 and CN200820104837.0)” in the background, the printing material manufacturer can buy the finished hot stamping foil (16) of the present invention at a cost lower than that it otherwise would cost in case of producing by its own, and transfers the anti-counterfeit identifying layer with a hot stamping texture (11) thereon onto the printing material body (3) with existing hot stamping processes and equipment, so as to fabricate “an anti-counterfeit printing material with a local texture (the seventh embodiment)”. In other words, the present invention replaces the original “texture anti-counterfeit identifying layer” which is fabricate directly with the anti-counterfeit identifying layer with a hot stamping texture (11), and leaves out several procedures for “a texture anti-counterfeit identifying layer” (e.g., printing an adhesive layer directly on the printing material, throwing fibers, removing redundant fibers, jet printing serial number, collecting by taking photo, or the like).

As a result, the printing material manufacturer can save huge investment in special equipment, simplify the production process of the printing material manufacturer, increase production efficiency, reduce production costs, and avoid pollution of fibers and dust.

As compared with the examples set forth in the background, by using the hot stamping foil of the present invention, in order to develop a daily production capacity of 100 thousands medicine boxes, the printing material manufacturer only needs to purchase a hot stamping machine at a price of about 100 thousands CNY (90% of printing enterprises already have such a hot stamping machine). In contrast, if the hot stamping foil and manufacturing method of the present invention is applied, each printing material manufacturer can save the investment in special equipment by more than 40 times, the production costs can be even lower, and it is possible to avoid pollution of fibers dust in the workshop.

Several complicated and polluting procedures for producing “a texture anti-counterfeit identifying layer (i.e., transferring layer)” (e.g., printing an adhesive layer directly on the printing material, throwing fibers, removing redundant fibers, jet printing serial number, collecting by taking photo, or the like, which is necessary for producing a hot stamping foil) can be fulfill by another professional factory. In this way, the present invention not only enables numerous printing material manufacturers to significantly save huge investment in special equipment, simplify the production process for the anti-counterfeit printing material manufacturers, increase production efficiency, reduce production costs, purify the workshop environment, and avoid pollution of fibers and dust.

As compared with “Structural texture anti-counterfeit method (CN99801139.8) in the background, the present invention provides a further anti-counterfeit technical measure, puts forward innovatively a technical measure of forming a texture (i.e., the texture formed by fibers) on a carrier (e.g. paper) which initially contains no texture (fibers), and make a breakthrough in the limit regarding “texture” in “Structural texture anti-counterfeit method” (CN99801139.8): “the structural texture is an intrinsic structure of the material of the carrier itself” as recorded on its description at paragraph [0016]. Therefore, a further new texture anti-counterfeit technique (in which there is no need to order a texture anti-counterfeit special paper) is obtained.

The anti-counterfeit identifying layer, with a hot stamping texture (11) which is transferred onto the printing material body (3) by hot stamping, are bound onto the printing material body (3) by a gluing layer (5), and the anti-counterfeit identifying layer with a hot stamping texture (11) can not be uncovered by a hair dryer for counterfeiting. Besides, the fibers further have a protruding handle, which can avoid imitating fibers by ink printing.

In order to make the above mentioned objects, features, and advantages of the present invention more apparent, preferred embodiments of the invention are described in detail hereinafter by referring to the accompanying drawings.

### BRIEF DESCRIPTION OF THE DRAWINGS

FIG. 1 is a structural view showing a cross section of an anti-counterfeit printing material with a hot stamping texture of the present invention (along A-B in FIG. 2).

FIG. 2 is a top structural view showing an anti-counterfeit printing material with a hot stamping texture of the present invention.

FIG. 3 is a top structural view showing a hot stamping foil of the present invention (with local fibers).

FIG. 4 is a cross-sectional structural view along C-D in FIG. 3.

FIG. 5 is a top structural view showing a hot stamping foil of the present invention (with fibers throughout the foil).

FIG. 6 is a cross-sectional structural view along E-F in FIG. 5.

FIG. 7 is a schematic view showing burrs at the edge of an anti-counterfeit identifying layer with a hot stamping texture.

FIG. 8 is another schematic view showing burrs at the edge of an anti-counterfeit identifying layer with a hot stamping texture.

FIG. 9 is a longitudinal cross-sectional structural view of one kind of fibers.

FIG. 10 is another top structural view showing an anti-counterfeit printing material with a hot stamping texture of the present invention.

FIG. 11 is FIG. 14 in “An anti-counterfeit printing material with a local texture (CN 200810091444.5)”.

FIG. 12 is another top structural view showing a hot stamping foil of the present invention (with local fibers).

FIG. 13 is a cross-sectional structural view along G-F in FIG. 12. FIG. 14 is another top structural view showing a hot stamping foil of the present invention which comprises a laser holographic layer (13).

FIG. 15 is a top structural view showing a hot stamping foil of the present invention after die cutting.

FIG. 16 is a cross-sectional structural view along H-J in FIG. 15. FIG. 17 is a structural view showing an anti-counterfeit bottle with a hot stamping texture.

Reference numerals: 1-fibers, 1′-remaining fibers, 2-identifying number, 2′-aluminum washing identifying number, 3-printing material body, 4-fiber layer, 5-gluing layer, 6-carrier layer, 7-burr, 8-adhesive layer, 9-protection layer, 9′-release layer, 10-hot melting glue layer, 11-anti-counterfeit identifying layer with a hot stamping texture, 12-mat layer or protection layer, 13-laser holographic layer, 14-notch, 15-blank gap, 16-hot stamping foil.

### DETAILED DESCRIPTION OF THE EMBODIMENTS

First embodiment

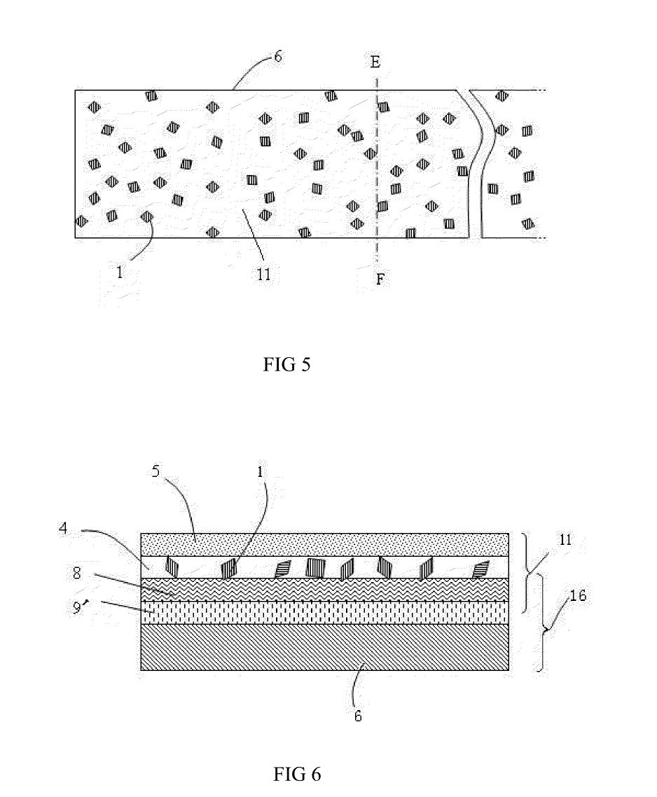

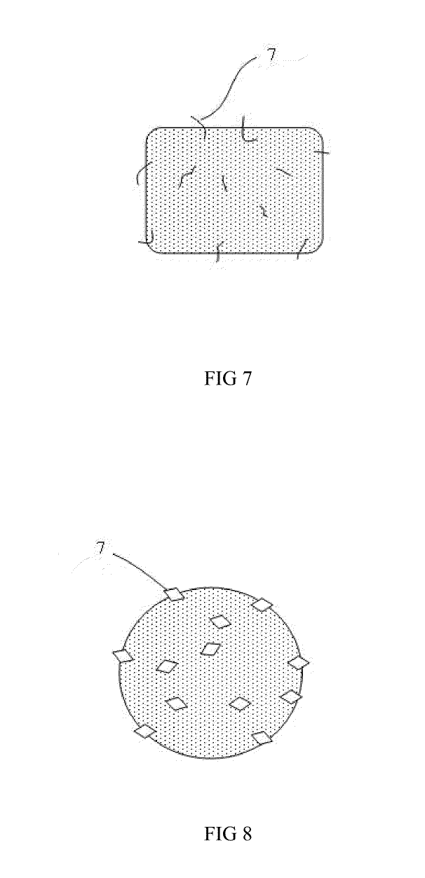

As shown in FIGS. 5 and 6, a transparent thin film coil of a biaxially oriented heat-resistant PET with a thickness of 25 μm is selected as a carrier layer (6). On one side of the carrier layer, a layer of release agent with a thickness of 2 pm is coated as a release layer (9′).

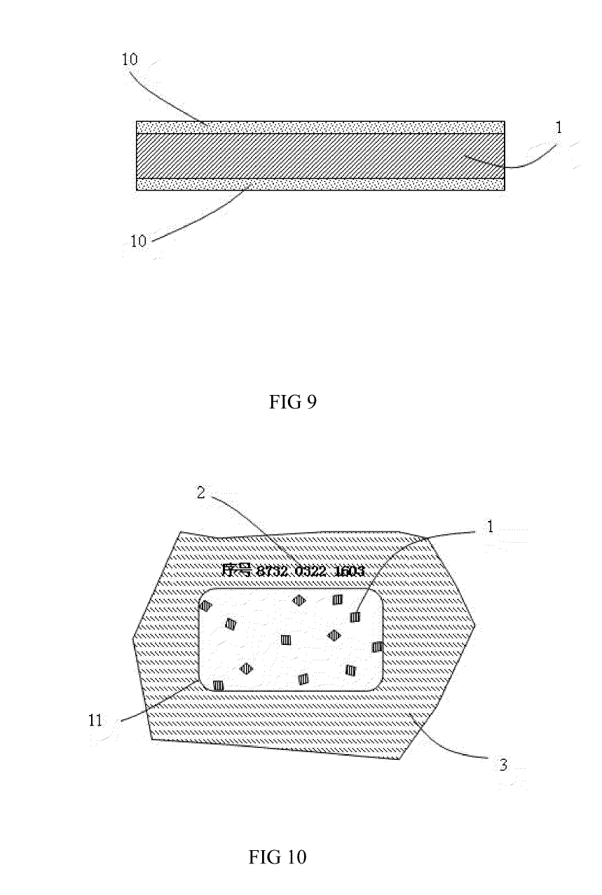

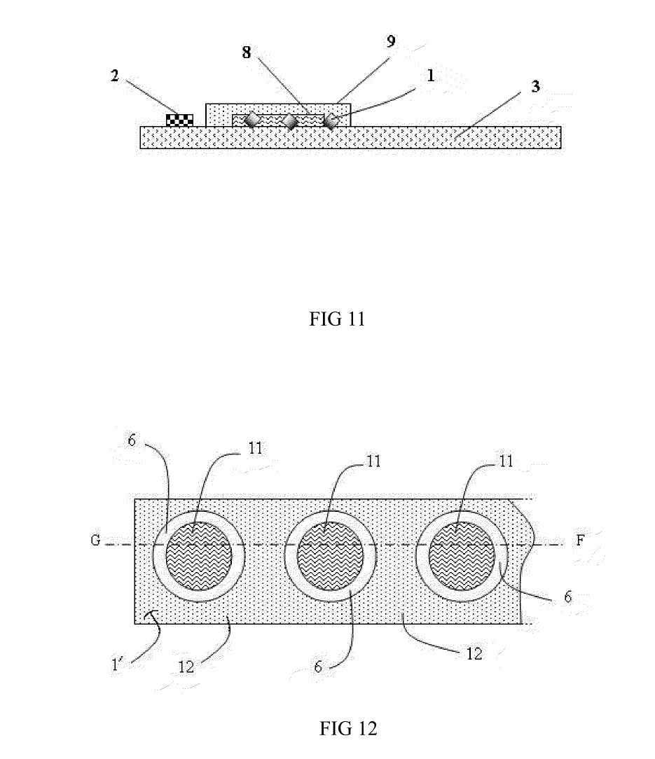

A layer adhesive layer (8) is coated all over the release layer (9′). As shown in FIG. 9, a PET heat-resistant thin film in a gold color with a thickness of 20 μm is selected, and a transparent hot melting glue layer (10) (e.g., with a melting point of 80-140° C.) with a thickness of 5 μm is coated on the front and back side of the film, respectively. It is preferred to add 1.5-3.2% ethoxylated alkyl amine and 2-5% rosin powder into the glue of the hot melting glue layer (10), so that the fibers do not wind and clot. After drying, the resultant as obtained is smashed into square pieces of 0.8 mm×0.8 mm with a powder machine, and fibers (1) the surface which is coated with the hot melting glue layer (10) are further formed. In order to enhance handle of fibers (1), thus facilitating the consumer to touch the fibers (1) with hands during inspection and verification of authenticity, the surface of said fibers (1) can further be coated with a layer of foaming microsphere (also referred to as foaming powder, foaming agent, foaming ink, which is commercially available and is not explained for simplicity). In this way, the foaming microsphere layer on the surface of fibers (1) will protrude upon hot stamping due to heating and foaming, so that the handle of fibers (1) can be enhanced. To prevent the counterfeiter from printing the imitated fibers (1), said fibers (1) are preferably multi-color segment metallic luster fibers. The ordinary skilled in the art of printing knows that graphics and text with metallic luster can only be realized by a hot stamping process, while the current hot stamping film is monochromatic, such as gold, silver, or other mono-color, and hot stamping films in variety of colors are not available. Therefore, by using multi-color segment metallic luster fibers, it is possible to significantly increase difficulty of imitation.

The fibers (1) in a form of square piece resulting from the previous step are sifted all over the adhesive layer (8) by a powder sprayer, so as to form a full-plate fiber layer (4) which is then dried.

The full-plate fiber layer (4) is baked at 80-140° C. , so that the hot melting glue layer (10) covering the surface of fibers (1) melts, and the full-plate fibers (1) is thus firmly bound onto the adhesive layer (8).

A layer of hot melting glue is sprayed or printed all over the fiber layer (4) as a gluing layer (5), and is dried to form a full-plate hot stamping foil (16) in which fibers (1) in the form of square pieces are randomly distributed.

As shown in FIG. 10, with the above mentioned hot stamping foil (16), an anti-counterfeit identifying layer with a hot stamping texture (11) consisting of multiple layers like the release layer (9′), the adhesive layer (8), the fibers (1), and the gluing layer (5) is hot stamped by a hot stamping machine By using a hot stamping plate of 26 mm×16 mm, an anti-counterfeit identifying layer with a hot stamping texture (11) of 26 mm×16 mm can be transferred onto a medicine box by hot stamping. By peeling the carrier layer (6) and jet printing the identifying number (9), the anti-counterfeit printing material with a hot stamping texture of the present invention is completed.

In order to make the consumer convenient to scrape fibers (1), so as to verify whether the fibers are fake fibers imitated by a printing ink, a UV isolating oil layer (not shown in the figure) is preferably printed on the printing material body (3) at the place where said anti-counterfeit identifying layer with a hot stamping texture (11) is located. As a result, the adhesion of the anti-counterfeit identifying layer with a hot stamping texture (11) is reduced to facilitate scraping and verifying.

Here, since fibers (1) are small square pieces of 0.8 mm×0.8 mm and substantially have no effect on the property of easy breaking of the anti-counterfeit identifying layer with a hot stamping texture (11). Therefore, it is possible for the hot stamping process to carry out smoothly. In contrast, if the fibers (1) are fiber threads with a length of 1.5-3.2 mm, the property of easy breaking of the anti-counterfeit identifying layer with a hot stamping texture (11) will be affected inevitably, so that the hot stamping process can not be carried out.

Finally, detailed random characteristic information of fibers (1) in the anti-counterfeit identifying layer with a hot stamping texture (11) (e.g., random characteristic information like the shape, orientation, color, precise location or the like of fibers) on each medicine box is collected with an image scanning and shooting device, and is stored along with the identifying number (2) in a database of a computer anti-counterfeit inquiry system connected to a telephone network and/or the Internet, for the consumer's inspection and verification of authenticity.

The first embodiment suffers from a drawback that for the anti-counterfeit identifying layer with a hot stamping texture (11) which is hot stamped onto the medicine box in pieces of 26 mm×16 mm, burrs (7) will inevitably appear along the edge, as shown in FIG. 8.

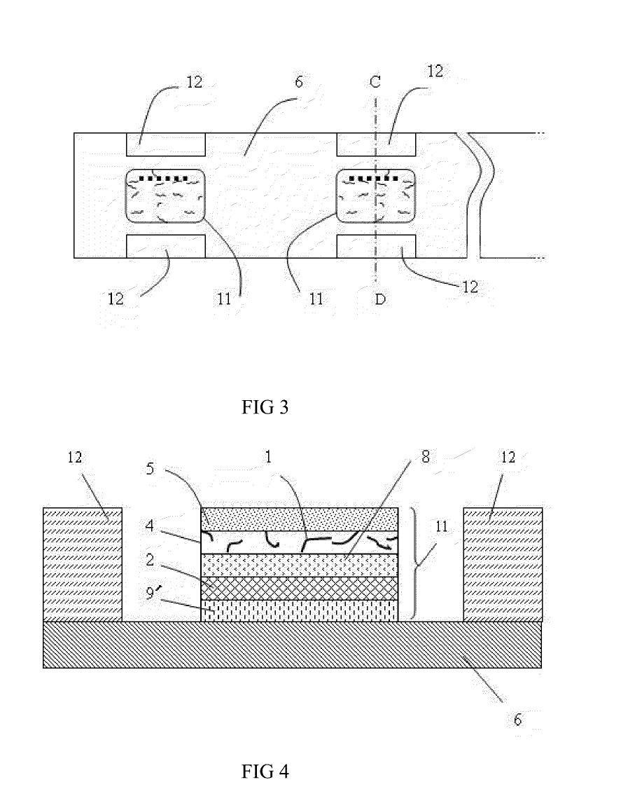

Second embodiment As shown in FIGS. 3, 4, 12, 13 and 14, a transparent thin film coil of a biaxially oriented heat-resistant PET with a thickness of 25 μm is selected as a carrier layer (6). On one side of the carrier layer, a layer of release agent with a thickness of 2 μm is coated as a release layer (9′). The release layer (9′) can not only be a full-plate coating, but also a printed layer which coincides in shape and size with the anti-counterfeit identifying layer with a hot stamping texture (11).

A set of identifying number (2) is formed on the release layer (9′) at a certain spacing by jet printing.

Pieces of adhesive layer (8) are further printed on the release layer (9′) at places corresponding to the identifying number (2).

As shown in FIG. 9, a PET heat-resistant thin film in a gold color or a iron foil with a thickness of 20 μm is selected, and a transparent hot melting glue layer (10) with a thickness of 5 μm is coated on the front and back side of the film/foil, respectively (e.g., with a melting point of 80-140° C.). After drying, the resultant as obtained is cut into strips of 0.2 mm×2 mm with a cutter, and fibers (1) the surface which is coated with the hot melting glue layer (10) are further formed.

In order to enhance handle of fibers (1), thus facilitating the consumer to touch the fibers (1) with hands during inspection and verification of authenticity, the surface of said fibers (1) can further be coated with a layer of foaming microsphere (also referred to as foaming powder, foaming agent, foaming ink, which is commercially available and is not explained for simplicity). In this way, the foaming microsphere layer on the surface of fibers (1) will protrude upon hot stamping due to heating and foaming, so that the handle of fibers (1) can be enhanced. To prevent the counterfeiter from printing the imitated fibers (1), said fibers (1) are preferably multi-color segment metallic luster fibers.

The fibers (1) from the previous step are sifted all over the adhesive layer (8) by a powder sprayer. The resulting fiber layer 4 is dried to fix fibers (1) which are adhered. The fibers (1), which are located at the adhesive-free region or are not adhered, are removed by a strong wind at negative pressure (or by a magnet).

The full-plate fiber layer (4) is baked at 80-140° C., so that the hot melting glue layer (10) covering the surface of fibers (1) melts, and the full-plate fibers (1) is thus firmly bound onto the pieces of adhesive layer (8).

Pieces of hot melting glue are printed on the fiber layer (4) as a gluing layer (5), so as to fully fix the fibers (1) to avoid dropping. Here, the adhesive used in the gluing layer (5) may be or may not be the same as that of the adhesive layer (8). Then, a transparent ink protection layer (12) is further printed at a region beyond the anti-counterfeit identifying layer with a hot stamping texture (11), so as to fully fix the remaining fibers (1′) in a small amount to avoid dropping.

The gluing layer (5) can not only be a full-plate coating, but also a printed layer which coincides in shape and size with the pieces of anti-counterfeit identifying layer with a hot stamping texture (11).

In order to avoid fiber burrs (7) along the edge of pieces of anti-counterfeit identifying layer with a hot stamping texture (11), the area for each layer is preferably set according to the following relationship: the area of gluing layer (5)≧the area of the anti-counterfeit identifying layer with a hot stamping texture (11)>the area of the fiber layer (4)>the area of the adhesive layer (8).

Finally, detailed random characteristic information of fibers (1) in the pieces of fiber layer (4) (e.g., random characteristic information like the shape, orientation, color, precise location or the like of fibers) is collected with a scanning device, and is stored along with the identifying number (2) on each piece in a database of a computer anti-counterfeit inquiry system connected to a telephone network and/or the Internet, thus completing the hot stamping foil (16) of the present invention. Detailed random characteristic information of fibers (1) of the invention is preferably recorded intuitively in a form of pictures (images) in the database, and naturally can be recorded in the database in the form of text, table, or code.

To facilitate automation for the hot stamping machine, the hot stamping foil can be cut into a reel in which pieces of identifiers are arranged.

In order to enable a smooth surface, a neat end face, and a large radius for the reel, to facilitate use, and to prevent the remaining fibers (1′) from dropping, a mat layer (12) (doubling as a protection layer), which will not be transferred by hot stamping, may be printed on the front or back side of the carrier layer (6) at a region beyond the anti-counterfeit identifying layer with a hot stamping texture (11). For example, the mat layer is a thick foamed ink layer, a thick ink layer free from a gluing layer (5) or the like. Besides, the thickness of the mat layer (12) is equal to or larger than that of the anti-counterfeit identifying layer with a hot stamping texture (11).

Said mat layer (12) widely refers to a thickening layer which is capable of increasing the local thickness of the hot stamping foil, e.g., an ink layer, a coating, a sticker layer, a film layer, a mould bump or the like.

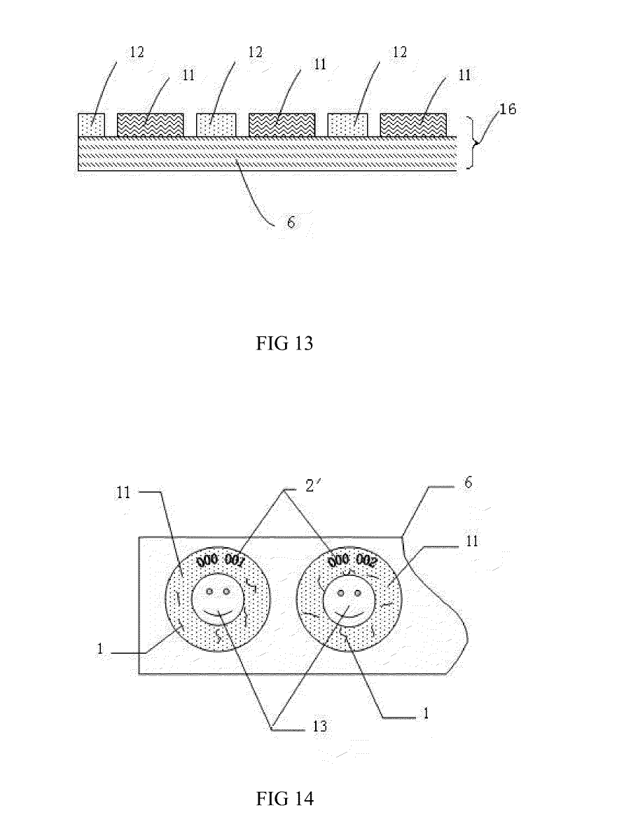

As shown in FIG. 13, in order to further increase the difficulty of imitation and to enhance anti-counterfeit effect and aesthetic effect, it is preferred to arrange a laser holographic (anti-counterfeit) layer (13) in the anti-counterfeit identifying layer with a hot stamping texture (11) (between any two layers). Besides, the identifying number (2) is formed with a UV ink by jet printing, and then formed into an aluminum washing identifying number (2′) by the aluminum washing process, so that the difficulty of imitation is further increased.

To facilitate the consumer verify authenticity of fibers (1) by scraping, a hot melting glue which is currently commercially available (online) under a product name of “oil scraping hot stamping back glue” is preferably used for said gluing layer (5).

Third embodiment

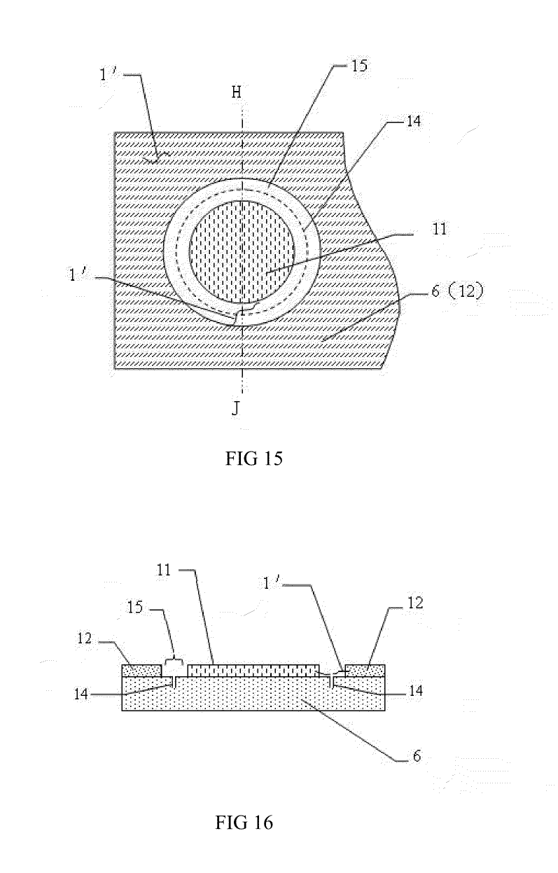

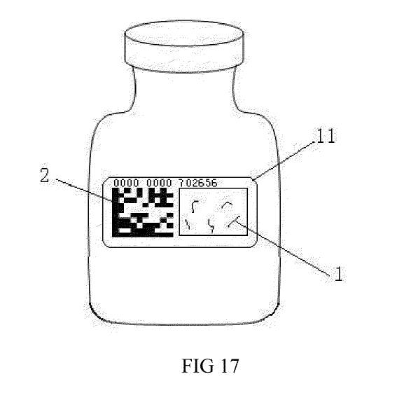

Referring to the second embodiment as well as FIGS. 15 and 16, it is assumed that pieces of anti-counterfeit identifying layer with a hot stamping texture (11) have a diameter of 26 mm. At a region which is 0.4 mm or more from the pieces of anti-counterfeit identifying layer with a hot stamping texture (11), a transparent ink protection layer (12) is printed, so that the remaining fibers (1′) in a small amount are fully fix to avoid dropping. In this way, a blank gap (15) which is a narrow region with a width of 0.4 mm is formed between the pieces of anti-counterfeit identifying layer with a hot stamping texture (11) and the protection layer (12).

To prevent the remaining fibers (1′) along the edge of the anti-counterfeit identifying layer with a hot stamping texture (11) from affecting the smooth performance of hot stamping and transferring, a die cutting plate with a diameter of 26.2 mm can be aligned with the blank gap (15) to form an interrupted continuous notch (14). As a result, the fibers (1′) remaining at the edge of the pieces of anti-counterfeit identifying layer with a hot stamping texture (11) are cut off In this way, the remaining fibers (1′) will not affect the cutting property of the hot stamping process, so that the hot stamping process can be performed smoothly at a high speed.

Fourth embodiment

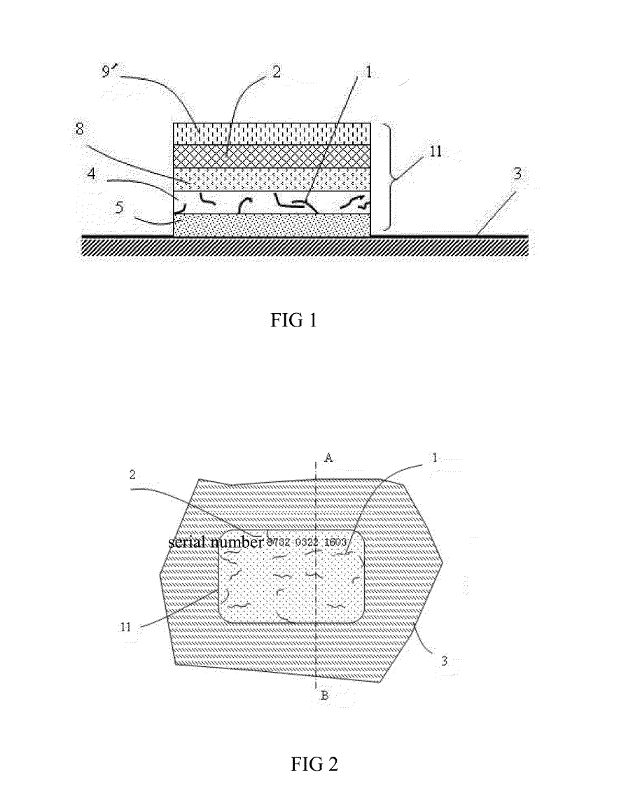

As shown in FIGS. 1 and 2, an anti-counterfeit printing material with a hot stamping texture, e.g., a medicine box, is fabricated (not completely shown in figures).

With the hot stamping foil (16) from the above embodiments, pieces of anti-counterfeit identifying layer with a hot stamping texture (11) consisting of multiple layers like the fibers (1), the adhesive layer (8), the identifying number (2), the release layer (9′) and the gluing layer (5) are respectively hot stamped and transferred (bound) onto each medicine box by a hot stamping machine. By peeling the carrier layer (6), the anti-counterfeit printing material with a hot stamping texture of the present invention, e.g., a medicine box is completed. The mat layer (12) is retained on the carrier layer (6), and thus is discarded along with the carrier layer (6) as waste.

Fifth embodiment

As shown in FIGS. 1, 2 and 17, an anti-counterfeit printing material with a hot stamping texture, e.g., a shampoo bottle is fabricated.

With the hot stamping foil (16) of the present invention, pieces of anti-counterfeit identifying layer with a hot stamping texture (11) consisting of multiple layers like the fibers (1), the adhesive layer (8), a two-dimensional code for anti-channel conflict and its digital identifying number (2), the release layer (9′), and the gluing layer (5) are respectively hot stamped and transferred (bound) onto each shampoo bottle by a hot stamping machine (or a hot transferring machine). By peeling the carrier layer (6), a shampoo bottle with a hot stamping texture anti-counterfeit is completed.

In the present invention, the specific components and formula of the gluing layer (5), the adhesive layer (8), the protection layer (9), the release layer (9′) and the oil scraping hot stamping back glue belong to the prior art in the field of heat transfer color film, and thus are not described in this embodiment.

The embodiments described above are only the preferred embodiments of the present invention, and do no intend to define the scope of the present invention in any way. Therefore, the modifications equivalent to the claims of the invention are covered by the present invention. In particularly, a degraded implementation in which the release layer (9′) is omitted deliberately still fall within the scope of the invention.

What is claimed is:

1. A special hot stamping foil for an anti-counterfeit printing material with a hot stamping texture, comprising an anti-counterfeit information layer, the anti-counterfeit information of the anti-counterfeit information layer is stored in a database of a computer anti-counterfeit inquiry system connected to a telephone network and/or the Internet, for public inspection and verification of authenticity, characterized in that the special hot stamping foil comprises:
\textcircled{1} a carrier layer (6);
\textcircled{1} an anti-counterfeit identifying layer with a hot stamping texture (11), which comprises in sequence a release layer (9′), an adhesive layer (8), a fiber layer (4) with randomly distributed fibers (1) and a gluing layer (5), wherein one side of said release layer (9′) is in contact with said carrier layer (6), while said gluing layer (5) is to be in contact with a printing material body (3); the area of said gluing layer (5)>the area of the fiber layer (4)>the area of the adhesive layer (8);
\textcircled{3} pieces of anti-counterfeit identifying layer with a hot stamping texture (11) are arranged on said carrier layer (6) at a certain spacing;
\textcircled{4} an identifying number (2) layer is further printed in each piece of anti-counterfeit identifying layer with a hot stamping texture (11);
\textcircled{5} said fiber layer (4) is said anti-counterfeit information layer, and characteristic information about the random distribution of said fibers (1) is said anti-counterfeit information.

2. The special hot stamping foil for an anti-counterfeit printing material with a hot stamping texture according to claim 1, comprising at least one of the following features:
\textcircled{1} a mat layer or protection layer (12) is printed on a region of said carrier layer (6) beyond the anti-counterfeit identifying layer with a hot stamping texture (11);
\textcircled{2} said anti-counterfeit identifying layer with a hot stamping texture (11) is embedded with a laser holographic layer (13);
\textcircled{3} the area of said gluing layer (5)≧the area of the anti-counterfeit identifying layer with a hot stamping texture (11)>the area of the fiber layer (4)>the area of the adhesive layer (8);
\textcircled{4} said gluing layer (5) uses an oil scraping hot stamping back glue;
\textcircled{5} the surface of said fibers (1) is coated with a hot melting glue layer (10) with a melting point of 80-140° C.; or the surface of said fibers (1) is coated with a foaming microsphere layer;
\textcircled{6} said fibers (1) are multi-color segment metallic luster fibers, or magnetic fibers which can be attracted by a magnet and overcome their own gravity to fly towards the magnet;
\textcircled{7} said fibers (1) have a length or particle diameter≧0.4-0.6 l mm;
\textcircled{8} said identifying number (2) is an aluminum washing identifying number (2′);
\textcircled{9} a blank gap (15) is arranged between said anti-counterfeit identifying layer with a hot stamping texture (11) and the protection layer (12), and the remaining fibers (1′) in the blank gap (15) are disconnected;
\textcircled{10} characteristic information about the random distribution of said fibers (1) is collected, and stored along with the identifying number (2) in a database of a computer anti-counterfeit inquiry system connected to a telephone network and/or the Internet.
